(19) United States
(12) Patent Application Publication
(10) Pub. No.: US 2009/0307858 A1
(43) Pub. Date: Dec. 17, 2009

(54) CLEANING MITT

(76) Inventor: Felicia Gionet, Nashua, NH (US)

Correspondence Address: Kristina M. Grasso;Kristina M. Grasso, Esq. PLLC, P.O. Box 162, Milford, NH, 03055, US

(21) Appl. No.: 12/544,491

(22) Filed: Aug. 20, 2009

Related U.S. Application Data
(63) Continuation-in-part of application No. 11/761,411, filed on Jun. 12, 2007.
(60) Provisional application No. 60/804,698, filed on Jun. 14, 2006.

(51) Int. Cl. B08B 1/00; A47L 13/10

(52) U.S. Cl. 15/104.93; 15/227

(57) ABSTRACT

A cleaning mitt with an opening for insertion of the user's hand, a section for the palm and fingers of the user, and at least three thumb holes which allow the mitt to be rotated 360 degrees on the user's hand to expose different surface areas without removing the mitt. The cleaning mitt is constructed from a unitary omnidirectional tubular piece of material. The material has a smooth surface and an opposing fabric looped surface. When formed, the cleaning mitt of the present invention has the smooth surface on the interior and the fabric looped surface on the exterior to facilitate the collection of dust and dirt. The cleaning mitt is reversible so it may be used with either side turned out and on either hand. All of the surface area of the mitt may be utilized by the user to collect dust and dirt by rotating the cleaning mitt sequentially and placing a thumb into another one of the thumb holes. This process is repeated until all of surface area has been used for cleaning.

### RELATED APPLICATIONS

This application claims the benefit of U.S. application Ser. No. 11/761,411 filed Jun. 12, 2007, which claims the benefit of U.S. Provisional Application No. 60/804,698, filed Jun. 14, 2006, which is herein incorporated in its entirety by reference.

### TECHNICAL FIELD

The invention relates to a cleaning device, and more particularly, to a mitt for cleaning, dusting, polishing and buffing a surface.

### BACKGROUND

There are a multitude of cleaning devices in the marketplace for cleaning, dusting, polishing and buffing. These devices include cloths, gloves and mitts. The cleaning devices of the prior art have several disadvantages. Cleaning cloths permit the users' hand to come into contact with the cleaning solution and/or the surface to be cleaned. Cleaning gloves, by having defined finger and thumb compartments, are oriented such that only one side of the device may be used to clean a surface. In order to use both sides, the glove must be removed and transferred to the other hand, which is an awkward process. Cleaning mitts often do not have a means to secure the mitt on the users' hand. Thus, there is a tendency for the mitt to slide off the users' hand when cleaning a surface.

What is needed, therefore, is a cleaning device that permits use on either hand of the user, allows all available surfaces to be used for cleaning, and has a means to secure the device on the hand of the user. The device should be simple in construction as well as easy and convenient to use.

### SUMMARY

It is a goal of the present invention to provide an improved cleaning device to solve the aforementioned problems.

One embodiment of the present invention provides a cleaning mitt with an opening for insertion of the user's hand, a section for the palm and fingers of the user, and at least three thumbholes which allow the mitt to be rotated 360 degrees on the user's hand without removing the mitt. This provides for greater dexterity when cleaning.

Another embodiment of the present invention provides a cleaning mitt having a one piece construction and made of a terry cloth or acrylic/polyester blend material.

One aspect of the present invention is to provide a cleaning mitt that is easy to use, easy to store, and inexpensive to manufacture.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a bottom view of one embodiment of the present invention.

FIG. 2 is a top view of one embodiment of the present invention.

FIG. 3 is a bottom view of one embodiment of the present invention, showing the smooth surface of the material.

FIG. 4 is a top view of one embodiment of the present invention, showing the smooth surface of the material.

FIG. 5 is a perspective view of one embodiment of the present invention.

### DETAILED DESCRIPTION

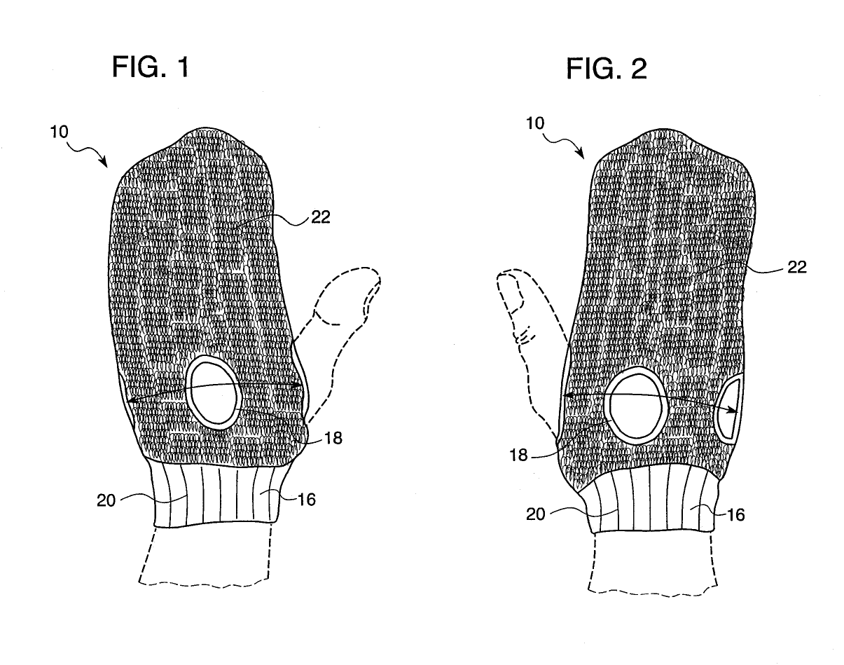

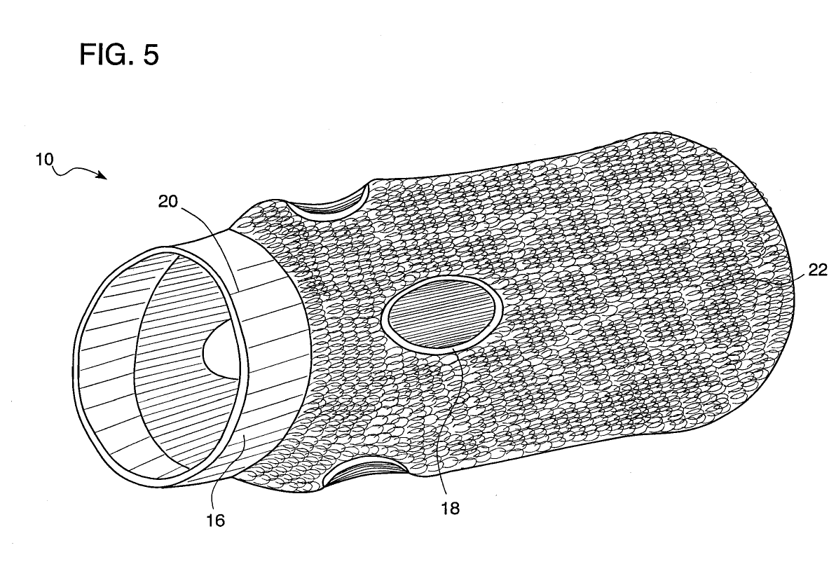

Referring to FIGS. 1 and 2, one embodiment of the cleaning mitt 10 is comprised of a palm side 12, a dorsal side 14, a wrist portion 16, and a series of thumb holes 18. Cleaning mitt 10 is constructed from a unitary omnidirectional tubular piece of material, such as terry cloth, as shown in FIG. 5. A suitable composition is a combination of acrylic, cotton, polyester and stretch nylon. Taken together, palm side 12 and dorsal side 14 form a surface area 22. The material is characterized by having a smooth surface and an opposing fabric looped surface. When formed, the cleaning mitt of the present invention has the smooth surface on the interior and the fabric looped surface on the exterior to facilitate the collection of dust and dirt. Other materials capable of attracting and retaining dust and dirt may be used, including, but not limited to, natural or synthetic fabrics such as wool or microfiber. These materials may be woven or non-woven.

In an alternative embodiment of the present invention, the material used to form the cleaning mitt is an electrostatically-charged fabric that attracts dirt and dust.

The wrist portion 16 is a closed band of material having sufficient resiliency so that it expands to slide over the hand and then contracts to firmly engage the wrist of the user. Preferably, wrist portion 16 is made from a ribbed material composed of acrylic, cotton, polyester and stretch nylon. Other materials may be used, including, but not limited to, elastane, spandex, or rubber. Ribs 20 extend in a lengthwise direction along wrist portion 16 allowing circumferential expansion of wrist portion 16. Alternatively, the ribs may also extend in a horizontal direction. Ribs 20 in combination with the elasticity of the material of wrist portion 16 permit expansion of wrist portion 16 beyond the normal opening size.

Thumb holes 18 are approximately a half inch in diameter, but may be larger or smaller, and adjacently spaced apart around a common circumferential axis of cleaning mitt 10 between wrist portion 16 and the base of surface area 22. In one embodiment, cleaning mitt 10 has four thumb holes. However, the number of thumb holes may be more or less. The edges of each thumb hole are worked over with fabric adhesive to prevent fraying or unraveling. Alternatively, the edges of each thumb hole are worked over with thread.

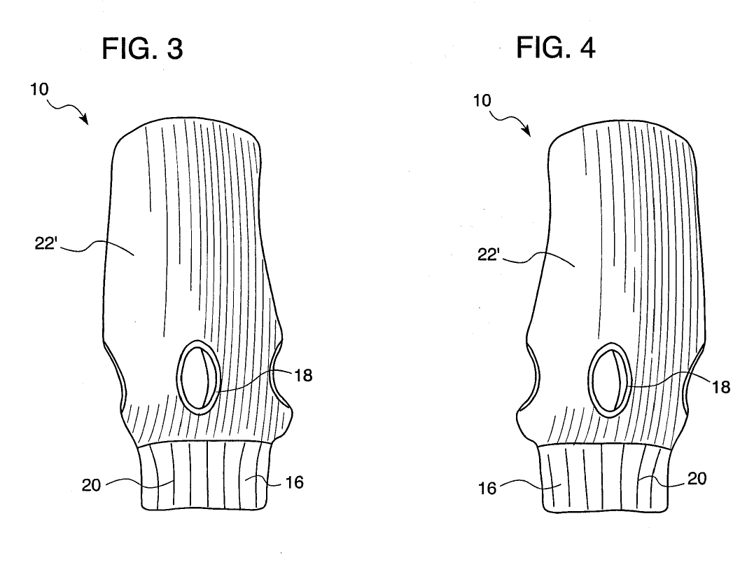

In one embodiment, shown in FIGS. 3 and 4, cleaning mitt 10 is reversible so it may be used with either side turned out and on either hand. Thus, palm side 12 and dorsal side 14 are interchangeable. The user inserts his or her hand into cleaning mitt 10 through an opening in wrist portion 16 and then inserts a thumb into one of the thumb holes 18. All of surface area 22 and 22′ may be utilized by the user to collect dust and dirt by rotating the cleaning mitt 10 sequentially and placing a thumb into another one of the thumb holes 18. This process is repeated until all of surface area 22 has been used for cleaning.

One advantage of this design is that the user does not have to completely remove the cleaning mitt from his or her hand in order to access a new surface area. Another advantage of this design is that the user still has the ability to pick up objects, e.g.: a pen, a telephone handset, and/or a cup, glass, or bottle, without having to remove the mitt because of the snug fit of the mitt on the hand and the thumb being exposed; thus, allowing the user to grip an object without it slipping out of the user's hand. Alternatively, a user may choose to wear a cleaning mitt on both hands for optimum use of time and motion when dusting or polishing a broad surface or a single object. In another alternative, the cleaning mitt may be worn over a rubber or latex glove.

Another advantage of this design is that it is easy to mass produce due to its simple shape and results in less waste of fabric, because only material in the area of the thumb holes is removed rather than adding material to form individual thumb or finger compartments. An additional advantage of this design is that the cleaning mitt may be laundered and reused or may be disposable in nature.

The cleaning mitt of the present invention is designed to be sized to fit the hand of an average sized adult. However, cleaning mitts may also be provided in additional sizes to accommodate smaller or larger sized hands. Cleaning mitts made of material having a degree of stretch to it provide for a range of hand sizes.

In one embodiment, the cleaning mitt is primarily intended for use on dry, hard surfaces as use with a polish or liquid could result in these substances passing through the fabric and coming into contact with the user's hand. In an alternative embodiment, the cleaning mitt is constructed with an inner liner that is impervious to moisture to allow for use of the mitt with furniture polishes or glass cleaners.

In an alternative embodiment, the cleaning mitt is constructed with a layer of absorbent material between an inner liner and surface area 22′ to enable the user to pick up liquid spills.

In yet another alternative embodiment, surface area 22 or a portion thereof is impregnated with a cleaning solution or polish; thus avoiding the need for two separate items.

In an additional alternative embodiment, surface area 22 is made of an abrasive material, such as mesh, plastic and/or natural fibers, to allow the cleaning mitt to be used for scrubbing and scouring of stubborn stains and/or debris.

In a further alternative embodiment, surface area 22 is made of chamois to allow the cleaning mitt to be used for buffing and polishing.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A mitt for cleaning comprising:
an omnidirectional tubular material with a closed end and an open end connecting to a wrist portion having an opening in which to insert a hand and adapted to engage a wrist of a user, a surface area for collecting debris from a surface, and at least three thumb holes adjacently spaced apart around a common circumferential axis of the mitt between the wrist portion and the surface area, wherein the mitt is rotatable 360 degrees on the hand of the user by utilizing the thumb holes to allow a user to utilize the surface area of the omnidirectional tubular material in its entirety.

2. The mitt of claim 1 wherein the mitt further comprises a palm side and a dorsal side.

3. The mitt of claim 1 wherein the mitt is made of a material selected from the group consisting of terry cloth, acrylic, cotton, polyester, stretch nylon, and a combination thereof.

4. The mitt of claim 1 wherein the omnidirectional tubular material has a smooth surface and an opposing fabric looped surface.

5. The mitt of claim 1 wherein the smooth surface of the omnidirectional tubular material is an interior surface of the mitt and the fabric looped surface is an exterior surface of the mitt.

6. The mitt of claim 1 wherein the mitt is made of a fabric selected from the group consisting of natural fabric, synthetic fabric, woven fabric, non-woven fabric, and a combination thereof.

7. The mitt of claim 1 wherein the mitt is made of an electrostatically charged fabric.

8. The mitt of claim 1 wherein the exterior surface of the mitt is made of chamois.

9. The mitt of claim 1 wherein the wrist portion is formed from a ribbed material, the ribbed material being selected from the group consisting of terry cloth, acrylic, cotton, polyester, stretch nylon, and a combination thereof.

10. The mitt of claim 1 wherein the ribbed material is selected from a group consisting of elastane, spandex, rubber or a combination thereof.

11. The mitt of claim 1 wherein the wrist portion has a plurality of ribs that extend along the wrist portion and allow for circumferential expansion of the wrist portion, the ribs being able to extend in a lengthwise direction and a horizontal direction.

12. The mitt of claim 1 wherein the thumb holes are at least a half inch in diameter.

13. The mitt of claim 1 wherein the mitt is reversible so it may be used with either the interior surface or the exterior surface turned out and on either hand of the user.

14. The mitt of claim 1 wherein the exterior surface of the mitt is impregnated with a product selected from the group consisting of cleaning solution, polish, and a combination thereof.

15. The mitt of claim 1 wherein the exterior surface of the mitt is made of an abrasive material, the abrasive material being selected from the group consisting of mesh, plastic, natural fibers, and a combination thereof.

16. A mitt for cleaning comprising: an omnidirectional tubular material with a closed end and an open end connecting to a wrist portion having an opening in which to insert a hand and adapted to engage a wrist of a user, an inner liner, the inner liner being impervious to moisture, and at least three thumb holes adjacently spaced apart around a common circumferential axis of the mitt above the wrist portion, and a surface area for collecting debris from a surface, wherein the mitt is rotatable 360 degrees on the hand of the user by utilizing the thumb holes to allow a user to utilize the surface area of the omnidirectional tubular material in its entirety.

17. A mitt for cleaning comprising: an omnidirectional tubular material with a closed end and an open end connecting to a wrist portion having an opening in which to insert a hand and adapted to engage a wrist of a user, an inner liner, the inner liner being impervious to moisture, a layer of absorbent material, the absorbent material being positioned between the omnidirectional tubular section and the inner liner, and at least three thumb holes adjacently spaced apart around a common circumferential axis of the mitt above the wrist portion, and a surface area for collecting debris from a surface, wherein the mitt is rotatable 360 degrees on the hand of the user by utilizing the thumb holes to allow a user to utilize the surface area of the omnidirectional tubular material in its entirety.
